(19) United States
(12) Patent Application Publication
(10) Pub. No.: US 2007/0064027 A1
(43) Pub. Date: Mar. 22, 2007

(54) Fixing control method and device

(75) Inventor: Je-Man Seo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/522,537

(22) Filed: Sep. 18, 2006

(30) Foreign Application Priority Data
Sep. 16, 2005 (KR) 2005-0086999

(51) Int. Cl. B41J 29/38

(52) U.S. Cl. 347/6

(57) ABSTRACT

A fixing control method and device are provided. An initial temperature change ratio of a fixer that is initially heated by applying a power supply voltage is detected. The initial temperature change ratio is compared with a reference change ratio and it is then determined whether a low power supply voltage is applied. If a low power supply voltage is applied, fixing control corresponding to the low power supply voltage is performed.

### PRIORITY

This application claims the benefit under 35 U.S.C. § 119(a) of Korean Patent Application No. 10-2005-0086999, filed Sep. 16, 2005, in the Korean Intellectual Property Office, the entire disclosure of which is hereby incorporated by reference.

### BACKGROUND OF THE INVENTION

1. Field of the Invention

The present invention relates to an image forming apparatus. More particularly, the present invention relates to a fixing control method and device of a fixer in an image forming apparatus.

2. Description of the Related Art

In a conventional fixing process, pressure and heat are applied to a toner that is attached to a print sheet via a weak electrostatic force, thereby fixing the toner to the print sheet.

In a conventional fixing control method, a power supply voltage is applied to a fixer to heat the fixer and the fixing control is performed using the heated fixer.

However, in the conventional fixing control method, because the same fixing control method is performed regardless of the size of the power supply voltage, printing quality can deteriorate. For example, if the conventional fixing control method is performed when a low power supply voltage is applied, the toner may not be adequately fixed to the print sheet.

### SUMMARY OF THE INVENTION

Accordingly, exemplary embodiments of the present invention provide a fixing control method and device which can perform fixing control under a low power supply voltage.

According to exemplary embodiments of the present invention, a fixing control method is provided that includes detecting an initial temperature change ratio of a fixer that is initially heated by applying a power supply voltage, comparing the initial temperature change ratio with a reference change ratio, determining whether a low power supply voltage is applied, and performing fixing control corresponding to the low power supply voltage if the low power supply voltage is applied.

According to another exemplary embodiment of the present invention, a fixing control device is provided that includes a temperature change ratio detecting unit for detecting an initial temperature change ratio of a fixer that is initially heated by applying a power supply voltage, a low power supply voltage determining unit for comparing the initial temperature change ratio with a reference change ratio and determining whether a power supply voltage is applied, and a fixing control unit for performing fixing control corresponding to the low power supply voltage if the low power supply voltage is applied.

### BRIEF DESCRIPTION OF THE DRAWINGS

The above and other exemplary features and advantages of the present invention will become more apparent from the following detailed description of certain exemplary embodiments thereof when taken in conjunction with the accompanying drawings, in which:

FIG. 1 is a flowchart illustrating a fixing control method according to an exemplary embodiment of the present invention;

FIG. 2 is a flowchart of an exemplary embodiment illustrating an example of step 10 illustrated in FIG. 1;

FIG. 3 illustrates a state of rising the temperature of a fixer by applying a power supply voltage;

FIG. 4 is a flowchart of an exemplary embodiment illustrating another example of step 10 illustrated in FIG. 1;

FIG. 5 is a block diagram illustrating a fixing control device according to an exemplary embodiment of the present invention;

FIG. 6 is a block diagram of an exemplary embodiment illustrating an example of a temperature change ratio detecting unit illustrated in FIG. 5; and

FIG. 7 is a block diagram of an exemplary embodiment illustrating another example of a temperature change ratio detecting unit illustrated in FIG. 5.

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

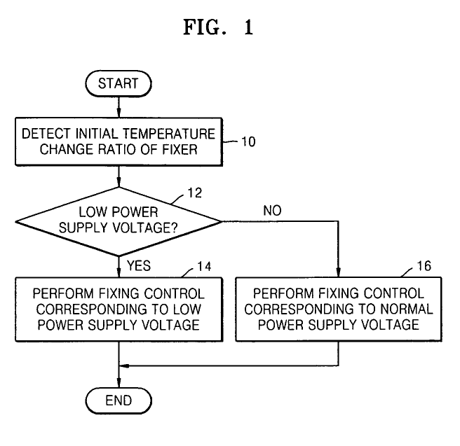

FIG. 1 is a flowchart illustrating a fixing control method according to an exemplary embodiment of the present invention. A fixer is initially heated by applying a power supply voltage and an initial temperature change ratio is detected, step 10. The initial temperature change ratio indicates the temperature change ratio occurring in the process of initially heating the fixer by applying the power supply voltage.

The initial temperature change ratio is detected in a range wherein the temperature of the fixer linearly rises. The initial temperature change ratio is detected in the range that the temperature linearly rises because reliability of the initial temperature change ratio is reduced when the initial temperature change ratio is nonlinear.

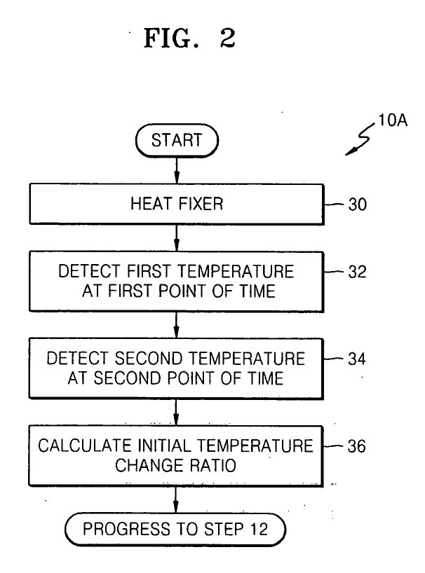

FIG. 2 is a flowchart illustrating example 10A of step 10 of FIG. 1.

The fixer is heated by applying a power supply voltage, step 30.

A first temperature is detected at a first point of time when the temperature of the fixer starts to linearly rise (operation 32).

The first point of time indicates an optimal point of time when the temperature begins to linearly rise. The first point of time comprises a value obtained through experiment. The temperature at the first point of time which is previously set is detected as the first temperature.

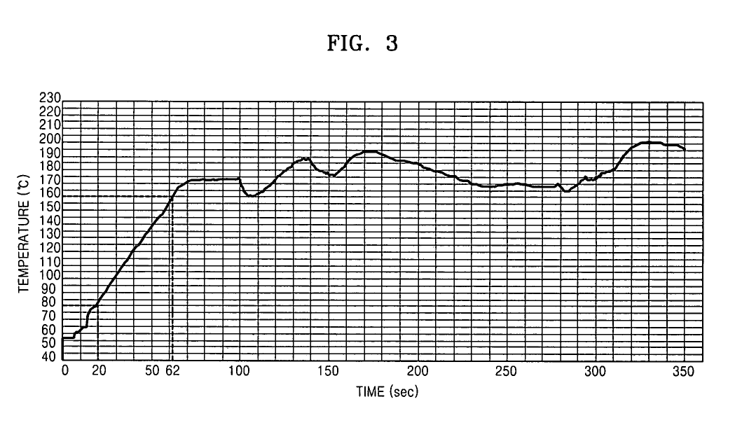

FIG. 3 illustrates a graph of the temperature rise of the fixer when applying a power supply voltage. Step 32 will be described with reference to the graph illustrated in FIG. 3. As illustrated in FIG. 3, if “20 [sec]” is previously set as the first point of time, “80 [° C.]” is detected as the first temperature in step 32.

After detecting the temperature at a first point in time, a second temperature is detected at a second point of time when the initial heating of the fixer is completed, step 34. The second point of time indicates the point of time when the initial heating of the fixer is completed, that is, the point of time when the application of power supply voltage for heating the fixer stops. As illustrated in FIG. 3, if “62 [sec]” is detected as the second point of time, “160 [° C.]” is detected as the second temperature in step 34.

The initial temperature change ratio is then calculated using the first point of time, the second point of time, the first temperature, and the second temperature step 36. The initial temperature change ratio can be obtained by calculating the temperature change during a certain period. That is, the initial temperature change ratio can be determined using Equation 1.
S=(T₂−T₁)/(t₂−t₁) Equation 1

In Equation 1, S denotes the initial temperature change ratio, t₁ denotes the first point of time, t₂ denotes the second point of time, T₁ denotes the first temperature, and T₂ denotes the second temperature.

As illustrated in FIG. 3, the initial temperature change ratio can be obtained using the first point of time of “20 [sec],” the first temperature of “80 [° C.],” the second point of time of “62 [sec],” and the second temperature of “160 [° C.].” Using these values, the initial temperature change ration is calculated as S=(160−80)/(62−20)≅1.905.

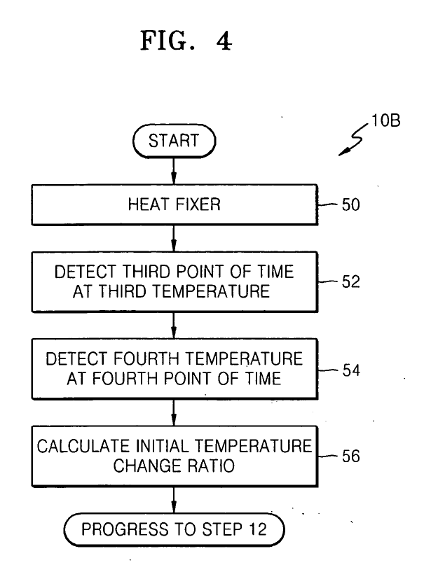

FIG. 4 is a flowchart illustrating another example 10B of step 10 of FIG. 1. The fixer is heated by applying a power supply voltage, step 50. A third point of time is then detected at a third temperature of the fixer which starts to linearly rise, step 52. The third temperature indicates an optimal temperature in which the temperature of the fixer begins to linearly rise. The third temperature comprises a value obtained through experiment. The point of time at which the third temperature is set is detected as the third point of time.

As illustrated in FIG. 3, if “80 [° C.]” is set as the third temperature, “20 [sec]” is detected as the third point of time in step 52.

A fourth temperature is then detected at a fourth point of time when the initial heating of the fixer is completed, step 54. The fourth point of time indicates the point of time when the initial heating of the fixer is completed, that is, the point of time when the application of power supply voltage for heating the fixer stops.

As illustrated in FIG. 3, if “62 [sec]” is detected as the fourth point of time, “160 [° C.]” is detected as the fourth temperature in step 54.

The initial temperature change ratio is then calculated using the third point of time, the fourth point of time, the third temperature, and the fourth temperature, step 56. The initial temperature change ratio can be determined using Equation 2.
S=(T₄−T₃)/(t₄−t₃) Equation 2

In Equation 2, S denotes the initial temperature change ratio, t₃ denotes the third point of time, t₄ denotes the fourth point of time, T₃ denotes the third temperature, and T₄ denotes the fourth temperature.

After step 10, the detected initial temperature change ratio is compared with a reference change ratio to determine whether a low power supply voltage has been applied, step 12. The reference change ratio is previously set as a threshold value for determining whether the low power supply voltage is applied. When the initial temperature change ratio is greater than the reference change ratio, it is determined that a normal power supply voltage has been applied; when the initial temperature change ratio is less than the reference change ratio, it is determined that a low power supply voltage has been applied.

For example, suppose that the reference change ratio is set to 2. If the initial temperature change ratio is greater than 2, it is determined that a normal power supply voltage has been applied. If the initial temperature change ratio is less than 2, it is determined that the low power supply voltage has been applied. In the example graph illustrated in FIG. 3, if the initial temperature change ratio is 1.905 and the reference change ratio is set to 2, it is determined that the low power supply voltage has been applied.

If a low power supply voltage is applied, fixing control corresponding to a low power supply voltage is performed, step 14. For example, if the initial temperature change ratio is 1.905 and the reference change ratio is set to 2, it is determined that the low power supply voltage is applied and fixing control corresponding to the low power supply voltage is performed.

In fixing control corresponding to a low power supply voltage, fixing time increases in proportion to the difference between the initial temperature change ratio and the reference change ratio. When a low power supply voltage is applied, the temperature of the fixer is lower than that when a normal power supply voltage is applied and the toner may not be adequately fixed to the print sheet. To improve fixing quality, when a low power supply voltage is applied, the fixing time can be increased.

In step 12, if a normal power supply voltage is applied, fixing control corresponding to a normal power supply voltage is performed, step 16. When normal power supply voltage is applied, toner is fixed to the print sheet by a general fixing control process.

Exemplary embodiments of the present invention can be implemented by computer readable codes/instructions/programs and implemented in general-use digital computers that execute the codes/instructions/programs using a medium such as a computer readable recording medium.

The computer readable medium can be any data storage device that can store data that can be read by a computer system. Examples of the computer readable media include read-only memory (ROM), random-access memory (RAM), CD-ROMs, magnetic tapes, floppy disks, optical data storage devices, and carrier waves (such as, for example, data transmission through the Internet).

Additionally, the computer readable code can be distributed over a network computer system so that the computer readable code is executed in a distributed fashion. Functional programs, codes, and code segments for accomplishing exemplary embodiments of the present invention can be construed by programmers skilled in the art to which the present invention pertains.

Hereinafter, a fixing control device according to an exemplary embodiment of the present invention will be described in detail with reference to the accompanying drawings.

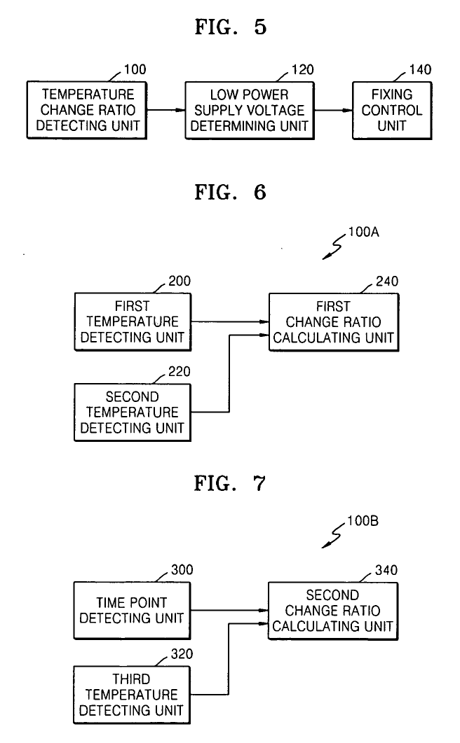

FIG. 5 is a block diagram illustrating a fixing control device according to an exemplary embodiment of the present invention. The fixing control device includes a temperature change ratio detecting unit 100, a low power supply voltage determining unit 120, and a fixing control unit 140.

The temperature change ratio detecting unit 100 detects an initial temperature change ratio of a fixer (not shown), which is initially heated by applying a power supply voltage, and outputs the detected result to the low power supply voltage determining unit 120.

The temperature change ratio detecting unit 100 detects the initial temperature change ratio in a range wherein the temperature of the fixer linearly rises.

FIG. 6 is a block diagram of an exemplary embodiment illustrating an example 100A of the temperature change ratio detecting unit 100 of FIG. 5. The temperature change ratio detecting unit 100A includes a first temperature detecting unit 200, a second temperature detecting unit 220, and a first change ratio calculating unit 240.

The first temperature detecting unit 200 detects a first temperature at a first point of time when the temperature of the fixer starts to linearly rise, and outputs the detected result to the first change ratio calculating unit 240. The first temperature detecting unit 200 includes a temperature sensor.

The first point of time indicates an optimal point of time when the temperature starts to linearly rise. The first point of time comprises a value obtained through experiment.

The second temperature detecting unit 220 detects a second temperature at a second point of time when the initial heating of the fixer is completed, and outputs the detected result to the first change ratio calculating unit 240. The second point of time indicates the point of time when the initial heating of the fixer is completed, that is, the point of time when the application of power supply voltage for heating the fixer stops. The second temperature detecting unit 220 includes a temperature sensor.

The first change ratio calculating unit 240 calculates the initial temperature change ratio using the first point of time, the second point of time, the first temperature, and the second temperature, which are provided by the first temperature detecting unit 200 and the second temperature detecting unit 220.

In an exemplary implementation, the first change ratio calculating unit 240 detects the initial temperature change ratio using Equation 1.

FIG. 7 is a block diagram of an exemplary embodiment illustrating another example 100B of the temperature change ratio detecting unit 100 of FIG. 5. The temperature change ratio detecting unit 100B includes a time point detecting unit 300, a third temperature detecting unit 320, and a second change ratio calculating unit 340.

The time point detecting unit 300 detects a third point of time at a third temperature of the fixer which starts to linearly rise, and outputs the detected result to the second change ratio calculating unit 340.

The third temperature indicates an optimal temperature which starts to linearly rise. The third temperature comprises a value obtained through experiment.

The third temperature detecting unit 320 detects a fourth temperature at a fourth point of time when the initial heating of the fixer is completed, and outputs the detected result to the second change ratio calculating unit 340. The fourth point of time indicates the point of time when the initial heating of the fixer is completed, that is, the point of time when the application of power supply voltage for heating the fixer stops. The third temperature detecting unit 320 includes a temperature sensor.

The second change ratio calculating unit 340 calculates the initial temperature change ratio using the third point of time, the fourth point of time, the third temperature, and the fourth temperature, which are provided by the time point detecting unit 300 and the third temperature detecting unit 320.

In an exemplary implementations, the second change ratio calculating unit 340 detects the initial temperature change ratio using Equation 2.

The low power supply voltage determining unit 120 compares the detected initial temperature change ratio with a reference change ratio to determine whether the low power supply voltage is applied, and outputs the detected result to the fixing control unit 140. The reference change ratio is set as a threshold value for determining whether a low power supply voltage has been applied.

The low power supply voltage determining unit 120 determines that a normal power supply voltage has been applied if the initial temperature change ratio is greater than a reference change ratio and determines that a low power supply voltage has been applied if the initial temperature change ratio is less than a reference change ratio.

When a low power supply voltage is applied, the fixing control unit 140 performs fixing control corresponding to the low power supply voltage. The fixing control unit 140 increases fixing time in proportion to the difference between the initial temperature change ratio and the reference change ratio. When a low power supply voltage is applied, the temperature of the fixer is lower than that when a normal power supply voltage is applied and the toner may not be adequately fixed to the print sheet. To improve fixing quality, when a low power supply voltage is applied, the fixing control unit 140 increases the fixing time such that the toner can be adequately fixed to the print sheet.

When a normal power supply voltage is applied, the fixing control unit 140 performs fixing control corresponding to the normal power supply voltage. When the normal power supply voltage is applied, the fixing control unit 140 fixes the toner to the print sheet via a general fixing control process.

In a fixing control method and device according to exemplary embodiments of the present invention, since the fixing control corresponding to a low power supply voltage is performed, it is possible to improve printing quality and prevent a fixing failure when a low power supply voltage is encountered.

While the present invention has been particularly shown and described with reference to certain exemplary embodiments thereof, it will be understood by those of ordinary skill in the art that various changes in form and detail may be made therein without departing from the spirit and scope of the present invention as defined by the following claims and equivalents thereof.

What is claimed is:

1. A fixing control method comprising:
detecting an initial temperature change ratio of a fixer;
comparing the initial temperature change ratio with a reference change ratio;
determining a power supply voltage applied to the fixer based on result of the comparing; and
performing fixing control corresponding to a low power supply voltage if the power supply voltage applied is low.

2. The fixing control method of claim 1, wherein detecting of the initial temperature change ratio comprises detecting in a range where the temperature of the fixer linearly rises.

3. The fixing control method of claim 2, wherein the detecting of the initial temperature change ratio comprises:
heating the fixer;
detecting a first temperature at a first point of time when the temperature of the fixer begins to linearly rise;
detecting a second temperature at a second point of time when the initial heating of the fixer is completed; and
calculating the initial temperature change ratio using the first point of time, the second point of time, the first temperature, and the second temperature.

4. The fixing control method of claim 3, wherein the first point of time comprises an optimal point of time when the temperature of the fixer begins to linearly rise.

5. The fixing control method of claim 2, wherein the detecting of the initial temperature change ratio comprises:
heating the fixer;
detecting a third point of time at a third temperature of the fixer in which the temperature of the fixer begins to linearly rise;
detecting a fourth temperature at a fourth point of time when the initial heating of the fixer is completed; and
calculating the initial temperature change ratio using the third point of time, the fourth point of time, the third temperature, and the fourth temperature.

6. The fixing control method of claim 5, wherein the third temperature comprises an optimal temperature of the fixer in which the temperatures begins to linearly rise.

7. The fixing control method of claim 1, wherein the reference change ratio comprises a threshold value for determining whether the power supply voltage applied is low.

8. The fixing control method of claim 1, wherein fixing time increases in proportion to the difference between the detected initial temperature change ratio and the reference change ratio.

9. The fixing control method of claim 1, further comprising performing fixing control corresponding to a normal power supply voltage if the power supply voltage applied is normal.

10. A computer readable medium having stored thereon instructions for fixing control, the instructions comprising:
a first set of instructions for detecting an initial temperature change ratio of a fixer;
a second set of instructions for comparing the initial temperature change ratio with a reference change ratio;
a third set of instructions for determining a power supply voltage applied to the fixer based on result of the comparing; and
a fourth set of instructions for performing fixing control corresponding to a low power supply voltage if the power supply voltage applied is low.

11. A fixing control device comprising:
a temperature change ratio detecting unit for detecting an initial temperature change ratio of a fixer;
a low power supply voltage determining unit for comparing the initial temperature change ratio with a reference change ratio and determining a power supply voltage applied to the fixer; and
a fixing control unit for performing fixing control corresponding to a low power supply voltage if the power supply voltage applied is low.

12. The fixing control device of claim 11, wherein the temperature change ratio detecting unit detects the initial temperature change ratio at least in a range where the temperature of the fixer linearly rises.

13. The fixing control device of claim 12, wherein the temperature change ratio detecting unit comprises:
a first temperature detecting unit for detecting a first temperature at a first point of time when the temperature of the fixer begins to linearly rise;
a second temperature detecting unit for detecting a second temperature at a second point of time when the initial heating of the fixer is completed; and
a first change ratio calculating unit for calculating the initial temperature change ratio using the first point of time, the second point of time, the first temperature, and the second temperature.

14. The fixing control device of claim 13, wherein the first point of time comprises an optimal point of time when the temperature of the fixer begins to linearly rise.

15. The fixing control device of claim 12, wherein the temperature change ratio detecting unit comprises:
a point time detecting unit for detecting a third point of time at a third temperature of the fixer which begins to linearly rise;
a third temperature detecting unit for detecting a fourth temperature at a fourth point of time when the initial heating of the fixer is completed; and
a second change ratio calculating unit for calculating the initial temperature change ratio using the third point of time, the fourth point of time, the third temperature, and the fourth temperature.

16. The fixing control device of claim 15, wherein the third temperature comprises an optimal temperature of the fixer in which the temperatures begins to linearly rise.

17. The fixing control device of claim 11, wherein the reference change ratio comprises a threshold value for determining whether the power supply voltage applied is low.

18. The fixing control device of claim 11, wherein the fixing control unit increases a fixing time in proportion to the difference between the detected initial temperature change ratio and the reference change ratio.

19. The fixing control device of claim 11, wherein the fixing control unit performs fixing control corresponding to a normal power supply voltage if the power supply voltage applied is normal.

20. The instructions of claim 10, wherein the detecting of the initial temperature change ratio comprises detecting in a range where the temperature of the fixer linearly rises.

21. The instructions of claim 20, wherein the first set of instructions for the detecting of the initial temperature change ratio comprise:
a fifth set of instructions for heating the fixer;
a sixth set of instructions for detecting a first temperature at a first point of time when the temperature of the fixer begins to linearly rise;
a seventh set of instructions for detecting a second temperature at a second point of time when the initial heating of the fixer is completed; and
a twelfth set of instructions for calculating the initial temperature change ratio using the first point of time, the second point of time, the first temperature, and the second temperature.

22. The instructions of claim 21, wherein the first point of time comprises an optimal point of time when the temperature of the fixer begins to linearly rise.

23. The instructions of claim 20, wherein the first set of instructions for the detecting of the initial temperature change ratio comprise:
a thirteenth set of instructions for heating the fixer;
a fourteenth set of instructions for detecting a third point of time at a third temperature of the fixer in which the temperature of the fixer begins to linearly rise;
a fifteenth set of instructions for detecting a fourth temperature at a fourth point of time when the initial heating of the fixer is completed; and
a sixteenth set of instructions for calculating the initial temperature change ratio using the third point of time, the fourth point of time, the third temperature, and the fourth temperature.

24. The fixing control method of claim 23, wherein the third temperature comprises an optimal temperature of the fixer in which the temperatures begins to linearly rise.

25. The instructions of claim 10, wherein the reference change ratio comprises a threshold value for determining whether the power supply voltage applied is low.

26. The instructions of claim 10, wherein fixing time increases in proportion to the difference between the detected initial temperature change ratio and the reference change ratio.

27. The instructions of claim 10, further comprising performing fixing control corresponding to a normal power supply voltage if the power supply voltage applied is normal.

28. The fixing method of claim 1, further comprising heating the fixer by applying the power supply voltage.

29. The fixing control device of claim 11, further comprising heating the fixer by applying the power supply voltage.
